(19) United States
(12) Patent Application Publication
(10) Pub. No.: US 2010/0184479 A1
(43) Pub. Date: Jul. 22, 2010

(54) System and Apparatus for Communicating Digital Data through Audio Input/Output Ports

(76) Inventor: Paul P. Griffin, JR., Nashville, TN (US)

Correspondence Address: HORNKOHL INTELLECTUAL PROPERTY LAW, P.L.L.C, P.O. BOX 210584, NASHVILLE, TN, 37221, US

(21) Appl. No.: 12/356,082

(22) Filed: Jan. 20, 2009

(51) Int. Cl. H04B 1/38

(52) U.S. Cl. 455/557

(57) ABSTRACT

A system for communicating digital data between a first and second device through audio input/output ports encodes the digital data into a series of audio frequency tones. The audio frequency tones are transferred between the devices as audio inputs. Audio decoding software residing on the devices monitors the audio inputs of the devices for audio signals representing digital data and decodes the audio signals into digital data when they are detected. The audio decoding and encoding software is preferably aftermarket software that is downloaded to the device through a digital data port and executed by the device's operating system software. The system can be used to provide a low cost accessory that can communicate digital data to a device without using the device's digital input/output port or requiring any expensive digital communication circuitry in the accessory.

### CROSS-REFERENCES TO RELATED APPLICATIONS

Not Applicable.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

For a number of reasons, many digital devices having audio outputs and/or inputs do not have digital data outputs or inputs. This limits the types of accessories that can be developed for the devices. For example, an Apple iPhone can receive digital data through a cellular transceiver. However, iPhone lacks the ability to load executable files through a physical port on the device. While an accessory can be constructed that has a cellular transceiver, the components required to construct such an interface make accessories having such an interface economically unviable.

### BRIEF SUMMARY OF THE INVENTION

An embodiment of the present invention is directed toward a system for receiving data between a first and second device. The first device has a microprocessor, an audio input, an audio output, and an operating system. The second device has a microprocessor, an audio input, and an audio output. The first device is preferably a mobile phone, such as an Apple iPhone™, or a similar portable media device. The second device is preferably a device for controlling the first device, such as a remote control or game control surface, or alternatively a device for enhancing the functionality of the first device such as an FM transmitter, voice recorder, or FM tuner.

The system includes software residing on the first device that monitors an audio input of the first device for a sequence of audio signals that represent a data transmission from an audio output of the second device. After the software determines a data transmission is taking place, the audio signals received by the first device are interpreted as digital data by the software in the first device. This activity is considered receiving an upstream data communication.

The system also includes software residing on the second device that monitors an audio input of the second device for a sequence of audio signals that represent a data transmission from an audio output of the first device. After the software determines a data transmission is taking place, the audio signals received by the second device are interpreted as digital data by said software in the second device. This activity is further described herein as receiving a downstream data communication.

The system also includes software residing on the first device that determines when data needs to be transmitted to the second device. Once this determination is made, the first device encodes the digital data into a sequence of audio signals and transmits the audio signals to the second device via an audio output on the first device. This activity is referred to as a transmission of a downstream data communication.

The system further includes similar software residing on the second device that determines when data needs to be transmitted to the first device. Once this determination is made, the second device encodes the digital data into a series of audio signals and transmits the audio signals to an audio input on the first device via an audio output on the second device. This activity is referred to as a transmission of an upstream data communication.

Another embodiment of the present invention is directed toward the transmission of digital data to an accessory from a portable electronic device, such as a mobile telephone, having a microprocessor, an audio input, an audio output, and an operating system. The accessory device includes a microprocessor, an audio input, and an audio output. The accessory device is preferably a device for enhancing the functionality of the portable electronic device, such as an FM transmitter, voice recorder, or FM tuner.

The portable electronic device includes software that determines when data needs to be transmitted to the accessory device. Once this determination is made, the software on the portable electronic device encodes the digital data to be transmitted into a series of audio signals and transmits the audio signals to the accessory device via an audio output on the portable electronic device. The frequency of the audio signals transmitted by the portable electronic device is preferably in the 19-20 kHz. The audio encoding process can be based on several methods, including generating the audio signals dynamically whenever data needs to be transmitted to the accessory, or by using a database of pre-rendered audio segments based on a common accessory command set to reduce the processing requirements on the portable electronic device.

The accessory device also includes software that monitors an audio input of the accessory device for a sequence of audio signals that represent a data transmission from an audio output of the portable electronic device. After the software determines a data transmission is taking place, the audio signals received by the accessory device are interpreted as digital data by the software in the accessory device in a downstream data communication. The audio decoding process can be based on several methods, including interpreting the audio signals dynamically into digital data whenever data is received, or comparing the audio received with a database containing common accessory commands to reduce the processing requirements on the accessory device.

Another embodiment of the present invention is directed toward a system for communicating digital data between a first and second device. The first device has a processor, an audio input, an audio output and an operating system. The system includes audio decoding software residing on the first device that monitors an audio input of the first device for audio signals representing digital data and decodes the audio signals into digital data when the audio signals are detected. Audio encoding software residing on the first device receives a digital data file and encodes the digital data into an audio file. Audio decoding software residing on the second device monitors an audio input of the second device for audio signals representing digital data and decodes the audio signals into digital data when the audio signals are detected. Audio encoding software residing on the second device that receives a digital data file and encodes the digital data into an audio file. The first device is preferably a mobile telephone and the encoding and decoding software is downloaded to the mobile telephone through a digital transceiver. The digital transceiver preferably includes an internet interface and the second device further comprises a digital input/output port such that internet data received from the first device can be transferred to a third device through the digital data input/output port. The second device is preferably a controller for the first device that includes control conversion software residing in the controller that generates audio control files based upon manipulation of controls on the controller. The audio control files are converted into digital control data for the first device by decoding software in the first device. Alternatively, the second device may be an FM transmitter for broadcasting an audio signal received from the first device to a FM stereo receiver or a voice recorder.

Another embodiment of the present invention is directed toward an accessory for an electronic device, such as an internet connected mobile phone, having a processor, a standard audio input jack and a digital data input. The accessory includes an audio file generator that generates an audio data file of frequency signals based upon digital data that includes an audio encoded version of the digital data. An audio output couples to the audio input of the electronic device to transfer the audio data file from the audio file generator to the electronic device. Software residing in the electronic device decodes the audio data file into a digital data file. The accessory has a digital data port for coupling to a computer. The accessory provides internet access to the computer through an internet interface on the electronic device. The software residing in the electronic device is downloaded to the device through the internet interface of the electronic device. The accessory includes an FM transmitter for transmitting audio from received from the electronic device to a FM stereo.

Yet another embodiment of the present invention is directed toward a method of communicating digital control data between an accessory and an electronic device having an audio input/output port. In accordance with the method, application software that is downloaded to the device through a digital data interface of the device. The digital data to be transferred from the accessory to the device is converted into an audio data file of selected frequency tones. The audio data file is transferred to the device through the audio input port of the device. The audio data file is converted back into the original digital data with the application software. To control the accessory, user inputs on the device are converted into digital control data for the accessory with application software, the digital accessory control data is converted into an audio file, the audio file is transferred to the accessory through the audio output of the device, the audio files are converted into digital data in the accessory and the control data is used to control a function of the accessory. The control data is preferably superimposed upon an existing audio output of the device. The accessory converts the existing audio output into a radio frequency modulated output and transmits the radio frequency modulated output to a remote FM stereo receiver.

### BRIEF DESCRIPTION OF THE SEVERAL VIEWS OF THE DRAWINGS

FIG. 1 is an illustration of an embodiment of the present invention adapted to transfer digital data between an accessory and mobile phone through an audio input/output port of the mobile phone;

FIG. 2 is a block diagram of an embodiment of the present invention for transferring digital data between an accessory and a device through audio input/output port;

FIG. 3 is a flow chart of a method of communicating digital control data between an accessory and an electronic device having an audio input/output port in accordance with an embodiment of the present invention;

FIG. 4 is a block diagram of an embodiment of the invention adapted for providing internet accessory to a computer through a second internet connected device;

FIG. 5 is an illustration of an embodiment of the invention adapted for providing internet accessory to a computer through a second internet connected device; and

FIG. 6 is a block diagram of an embodiment of the invention adapted for providing internet accessory to a computer through a second internet connected device.

### DETAILED DESCRIPTION OF THE INVENTION

A preferred embodiment of the present invention includes software residing in the accessory and device that convert digital data into audio files of various frequency audio tones and then processes the audio file to decode the digital data. These audio files can then be transferred through the audio input/output ports of the device and accessory. The use of the audio port to transfer digital data between the device and accessory allows the accessory to be constructed without the need for the expensive and complicated digital wireless communication chips and hardware. Much of this hardware is proprietary and restricted while the audio input/output of the devices are typically standardized around the standard audio jack.

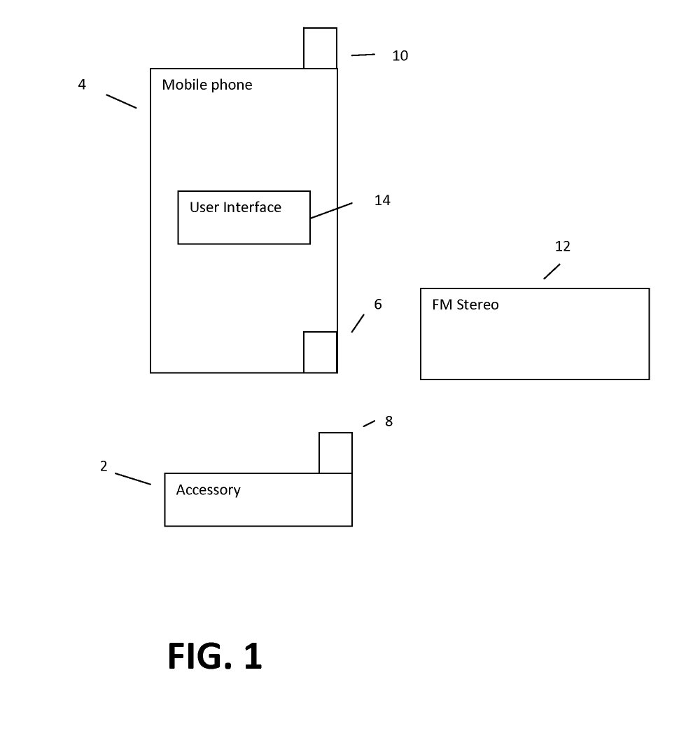

FIG. 1 is an illustration of an embodiment of the present invention adapted to transfer digital data between an accessory 2 and mobile phone 4 through an audio input/output port 6 of the mobile phone. In the embodiment shown, the accessory 2 has a male audio jack 8 that mates with the female audio jack 6 of the mobile phone 4. Although a standard audio jack 6 and 8 is shown, any type of audio input/output port may be used.

Application software is downloaded from the internet to the mobile phone 4 through the mobile phone's wireless digital transceiver 10. The application software runs on the operating system of the mobile phone 4. The application software converts digital data to be sent to the accessory 2 into audio files having the data encoded in the form of a series of audio tones. The application software also converts audio files received from the accessory into digital data that can be utilized for any of a number of functions. The application software can be user initiated or examine all received audio for a series of audio tones that identify the audio input as an audio data file from the accessory 2.

The accessory can be any type of accessory or device that might need to communicate digital data to the accessory. For example, the accessory 2 may be an FM transmitter for transmitting audio outputs from the phone 4 to an FM stereo receiver 12. In such an embodiment, it is use to be able to use the phone controls to set the frequency of the FM transmitter. The phone 4 is controlled by the application software that is executed on its operating system software. The accessory 2 allows digital control data to be generated by the application software in the mobile phone 4 based on a user manipulating the controls 14 of the phone 4 and then transferred to the transmitting accessory in the form of a series of audio tones through the audio output port 6 of the phone 4. The accessory then interprets the received audio file and implements the corresponding control functions such as raising the output volume or setting the transmitter frequency.

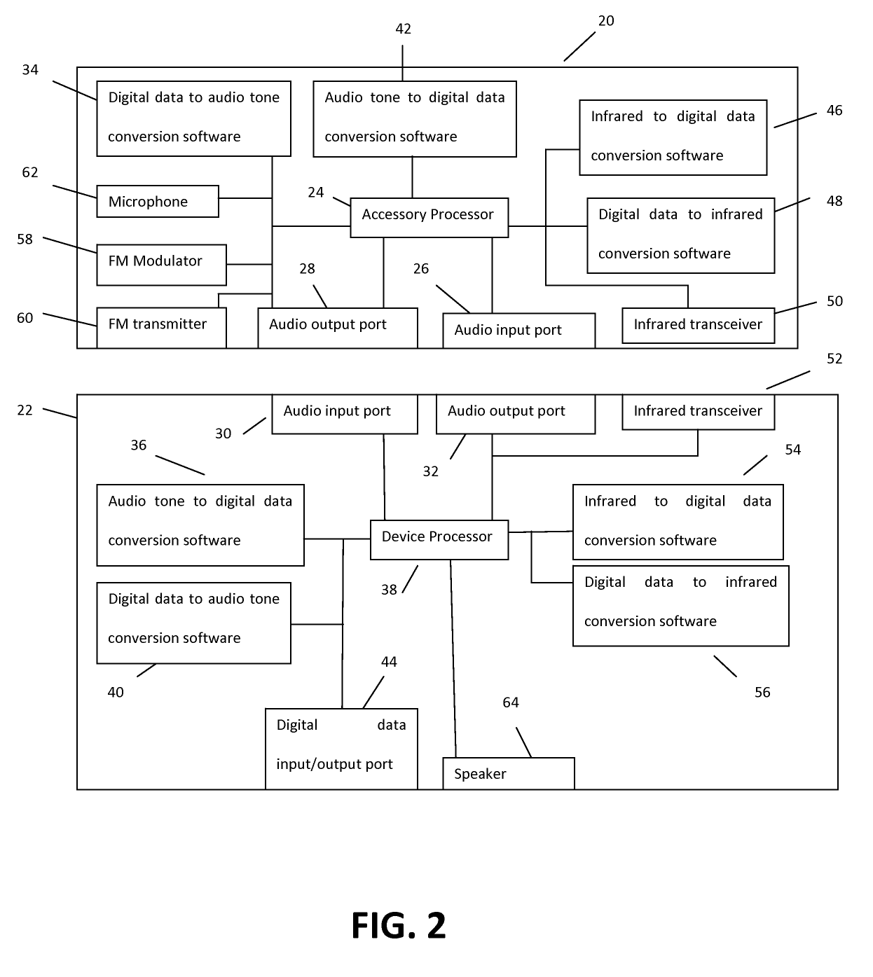

FIG. 2 is a block diagram of an accessory 20 for a device 22 constructed in accordance with an embodiment of the present invention. The functions of the accessory 20 are managed by an accessory processor 24. The accessory communicates with device through an accessory audio input 26 and output 28 that couple with a device audio input 30 and output 32.

When the accessory wants to communicate digital data to the device, the accessory processor 24 uses digital data to audio tone conversion software 34 to create an audio file having varying frequency tones that varied in accordance with a predetermined scheme to form an encoded version of the digital data. The audio file is then transferred to the device audio input port 30 through the accessory audio output 28. Audio tone to digital data conversion software 36 is executed by the device processor 38 to decode the received audio file into the original digital data. The digital data can then be used by any of the programs running on the device 22.

When the device 22 wants to communicate digital data to the accessory 20, the device processor 38 uses digital data to audio tone conversion software 40 to create an audio file having varying frequency tones that varied in accordance with the predetermined scheme to form an audio encoded version of the digital data. The audio file is then transferred to the accessory audio input port 26 through the device audio output 32. Audio tone to digital data conversion software 42 is executed by the accessory processor 24 to decode the received audio file into the digital data from which the audio file was created. The digital data can then be used by accessory as needed.

Digital data can be also transferred from the accessory 20 to the device 22 through an infrared encoding scheme. The digital data to be transferred between the accessory 20 and the device 22 is converted into a series of infrared signals by infrared conversion software 46 and 48 residing in the accessory 20 and similar infrared conversion software 54 and 56 residing in the device 22. The infrared signals are transferred between the device 22 and accessory 20 through respective infrared transceivers 50 and 52. Infrared ports are provided on many devices so that the device can receive remote control signals. By repurposing the control codes into infrared signals representing digital data, digital data can be transferred from the accessory 20 to the device 22, or vice versa, without using the device's digital input/output port. In addition, the accessory does not require expensive digital communication circuitry and can be constructed from inexpensive components. For example, an infrared signal corresponding to volume up remote control signal received from the accessory 20 through the device's infrared port 52 can be interpreted as a digital one by infrared conversion software 54 in the device 22 and a volume down control signal can be interpreted as a digital zero. By converting a digital data file to a series of volume up and down controls, the accessory 20 can transfer digital data to a device 22 through the device's existing infrared port. Once the digital data file has been reconstructed by the device, the data can be displayed or executed by the device. By providing the accessory 20 with both audio and infrared encoding circuitry, a single accessory can be created that can be used with a wide variety of different types of devices.

The conversion software for the device is preferably downloaded through a digital data input/output port 44 on the device 22. Since the software is downloaded to the device, an accessory can easily be designed for a pre-existing device that was not designed for use with such an accessory and the functioning of the accessory can be upgraded after its construction and purchase. Alternatively, the conversion software can be installed on the device at the factory if the device is specially designed to be used with an accessory that communicates in the manner specified.

An FM modulator 58 and transmitter 60 may be included in the accessory 20 to enable the accessory to transmit audio from the device 22 to an FM stereo receiver as described more detail herein. The device controls can be used to set the transmission frequency of the modulator and transmitter 60 through the transfer of encoded audio files. In such an embodiment, it is use to be able to use the phone controls to set the frequency of the FM transmitter. A microphone 62 on the accessory can be used to provide the accessory with a voice recording functionality. The audio from the microphone 62 can be transmitted to the device 22 directly as analog audio while control signals for implementing the voice recorder functionality are received as encoded audio files from the device 22. The voice recorded samples can be saved in the device 22 and played on the device's speaker 64. Any data transmitted between the accessory 20 to the device 22 can be encoded at ultrasonic frequencies and superimposed on concurrently transmitted audio files such that the digital data signals can be communicated without noticeably interfering with the use of the audio output.

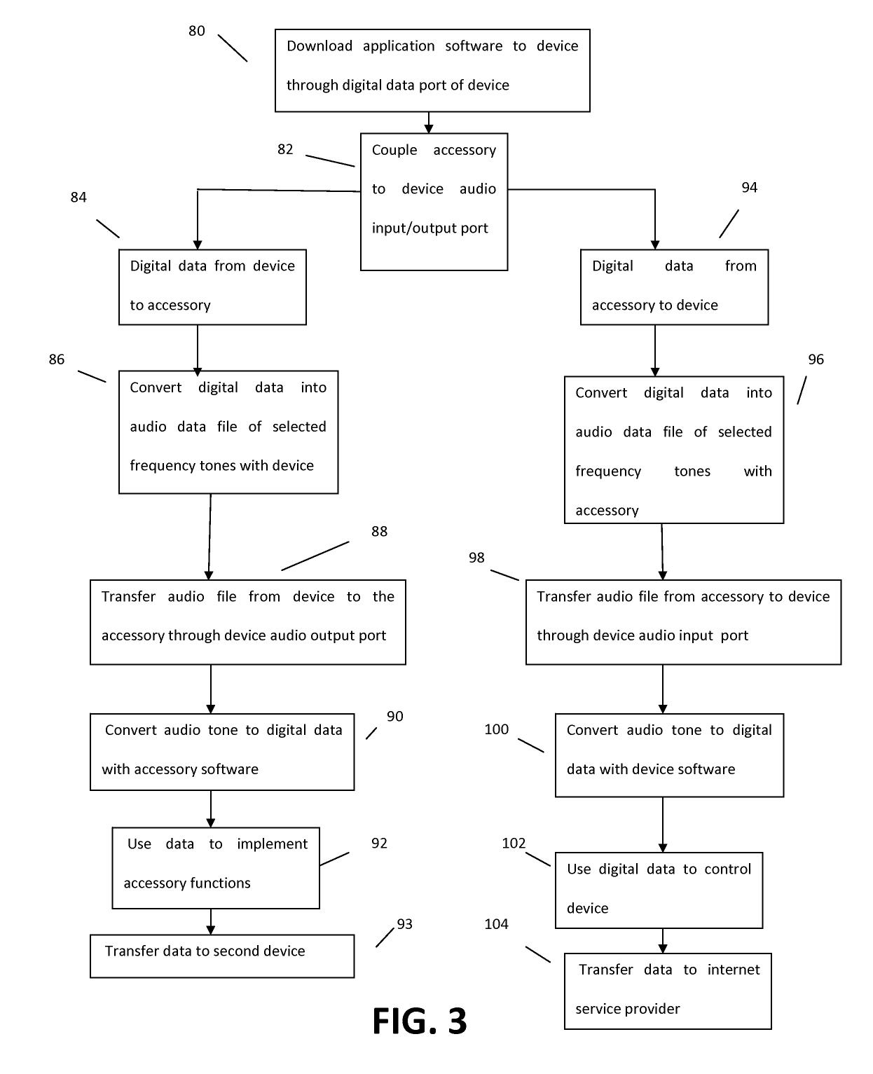

FIG. 3 is a flow chart of a method of communicating digital control data between an accessory and an electronic device having an audio input/output port in accordance with an embodiment of the present invention. The method commences in step 80 with the downloading of application software a device through a digital data interface of the device. In step 82, the accessory is coupled to the audio input/output port of the device. If digital data needs to be transmitted from the device to the accessory, the method proceeds to step 84 and the device application software converts the digital data into an audio data file of selected frequency tones in step 86. The audio file is then transferred to the accessory through the devices audio output port in step 88. The audio data file is converted back into the original digital data with the software in the accessory as shown in step 90. Once the audio data has been converted into digital data, the digital data can be used to control the accessory's functions as shown in step 92. This is accomplished by converting user inputs on the device into digital control data for the accessory with application software, converting the digital accessory control data into an audio file, transferring the audio file to the accessory through the audio output of the device, converting the audio files into digital data in the accessory and using the control data to control a function of the accessory. The control data is preferably converted into audio frequencies in the range of 19-20 kHz and superimposed upon an existing audio output of the device. The digital data can also be transferred to a second device by the accessory as shown in step 93.

If digital data needs to be transmitted from the accessory to the device, the method proceeds to step 94 and the accessory's application software converts the digital data into an audio data file of selected frequency tones in step 96. The audio file is then transferred to the device from the accessory through the device's audio output port in step 98. In step 100, the audio data file is converted back into the original digital data with the software in the device. The digital data can then be used to control a device function as shown in step 102 or transferred to an internet service provider by the device as shown in step 104.

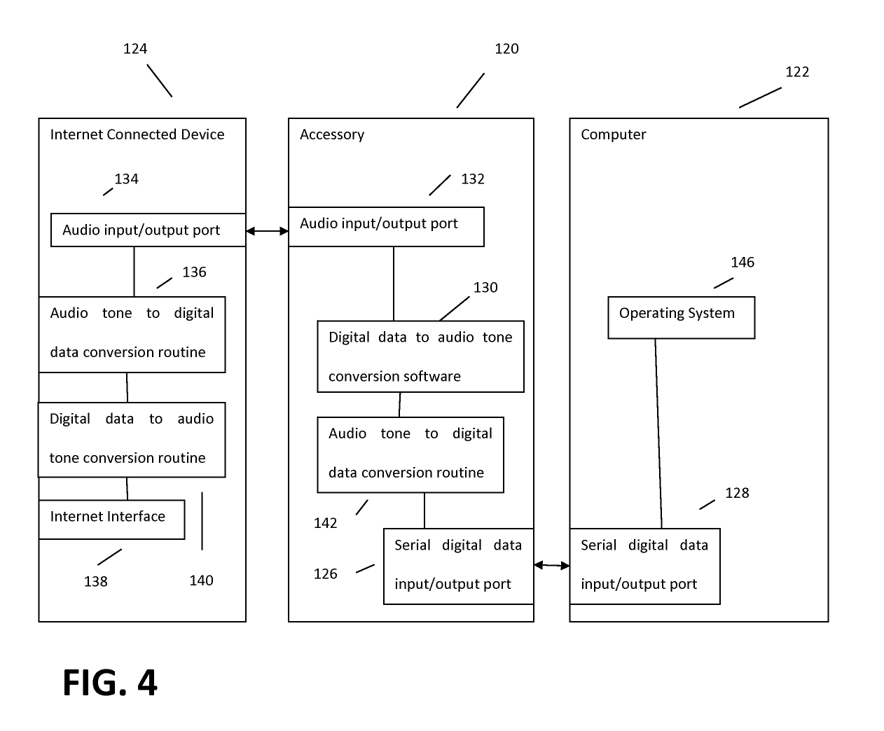

FIG. 4 is a block diagram of an accessory 120 constructed in accordance embodiment of the invention that is adapted for providing internet accessory to a computer 122 through a second internet connected device 124. The accessory 120 has a serial digital communication port 126 that couples to the computer 122 through a digital data computer port 128 such as a USB or RS232 port. Conversion software 130 in the accessory converts digital data received from the computer into audio tones. The audio tones are transmitted to the internet equipped device 124, such as a mobile phone, from an accessory audio input/output port 132 that is coupled to the device's audio input port 134. The device 124 has audio to digital data conversion software 136 that converts the received audio file into digital data that is provided to the device's internet interface 138. Digital data received from the internet interface 138 is converted into an audio file by digital data to audio conversion software 140 in the device 124 and transmitted to the accessory 120 through the device's audio input/output port 134 to the accessory's audio output/input port 132. The accessory 120 then converts the audio file received from the internet enabled device 124 into digital data with audio to digital data conversion software 142 that is provided to the computer's digital data input/output port 128 through the accessories digital input/output port 126. Thus, the computer 122 is able to share the device's internet interface 138 through the device's audio input/output port 134. The audio files can be transmitted and received in short burst between the accessory 120 and the device 124 to effectively transmit packet formatted data between accessory and the device through its audio input/output port 134. Application software can be executed by the computer's operating system 146 to handle the reception of data from, and transmission of data to, the accessory 120.

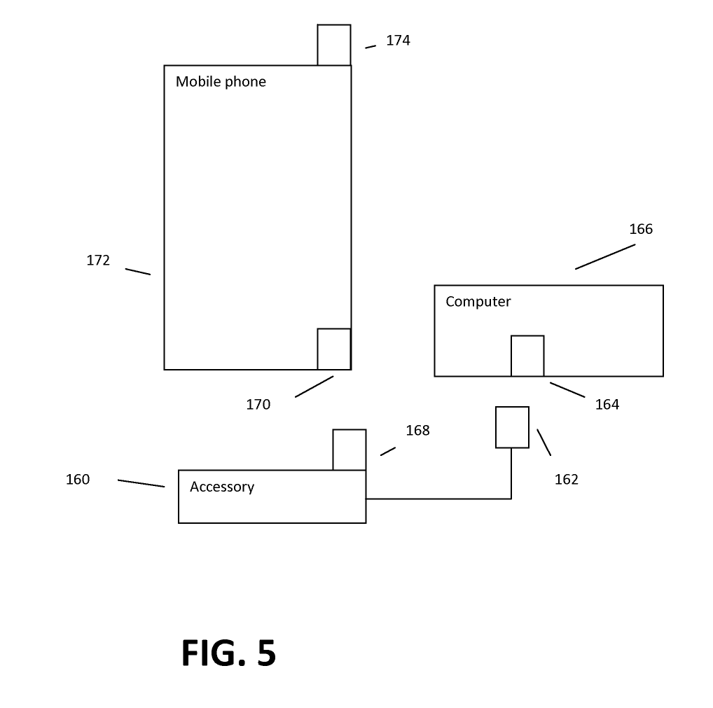

FIG. 5 is an illustration of an embodiment of the invention adapted for providing internet accessory to a computer through a second internet connected device. The accessory 160 has a small housing with a connector 162 for connecting to the digital output 164 of the computer 166 and an audio input/output jack 168 that couples to the audio input/out jack 170 of an internet enabled mobile phone 172. The mobile phone 172 can then transfer digital data to and from the internet through its cellular transceiver 174 that is communicated to the computer 166 through the accessory 160 as discussed with respect to FIG. 4.

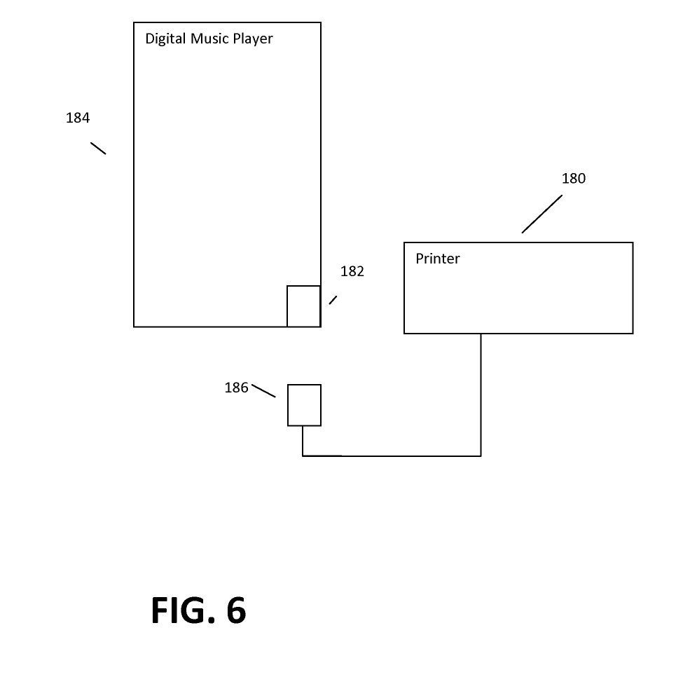

Alternatively, the present method for transferring data can be embodied in a printer 180 that prints a file received from a digital music player's audio output 182 as shown in FIG. 6. The audio file generating software resides in the printer 180 and the digital music player 184. The printer 180 is coupled to the music player 184 through a connector 186 that connects to the music player's audio/input port 182. Data can then be communicated between the printer 180 and the music player 184 in the manner described in more detail herein. The printer can have an internal power supply, external power supply connection, or be a parasitic device that receives power from the music player depending upon the desired configuration.

What is claimed is:

1. A system for communicating digital data between a first and second device, wherein said first device has a processor, an audio input, an audio output, and an operating system and said second device has a microprocessor, an audio input, and an audio output; said system comprising:
software residing on the first device that monitors an audio input of the first device for a sequence of audio signals that represent a data transmission from an audio output of the second device and interprets said audio signals as digital data;
software residing on the second device that monitors an audio input of the second device for a sequence of audio signals that represent a data transmission from an audio output of the first device and interprets said audio signals as digital data;
software residing on the first device that encodes digital data into a sequence of audio signals and transmits said audio signals to the second device via an audio output on the first device; and
software residing on the second device that encodes digital data into a sequence of audio signals and transmits said audio signals to the first device via an audio output on the second device.

2. The system of claim 1 wherein said second device is a controller for said first device further comprising control conversion software residing in said controller that generates audio control files based upon manipulation of controls on said controller wherein said audio control files are converted into digital control data for said first device by said decoding software in said first device.

3. The system of claim 1 wherein said first device is a mobile telephone and said encoding and decoding software is downloaded to said mobile telephone through a digital transceiver.

4. The system of claim 1 wherein said second device further comprising an FM transmitter for broadcasting an audio signal received from said first device to a FM stereo receiver.

5. The system of claim 1 wherein said first device further comprises an internet interface and said second device further comprises a digital input/output port such that internet data received from said first device can be transferred to a third device through said digital data input/output port.

6. The system of claim 1 wherein said sequence of audio signals is transmitted at a frequency greater than approximately 19 kHz.

7. An accessory for a portable electronic device having a processor and an audio output and a digital data input; said accessory comprising:
an audio input that receives an audio signal from an audio output of said electronic device; and
software that processes said audio signal to identity encoded audio data and interprets the encoded audio data as digital control data for the accessorying an encoded audio signal based upon digital data and reconstructing the original digital data for use by the accessory.

8. The accessory of claim 7 further comprising a digital data port for coupling to a computer wherein said accessory provides internet access to said computer through an internet interface on said electronic device.

9. The accessory of claim 7 further comprising an FM transmitter for transmitting audio received from said electronic device to a FM stereo.

10. The accessory of claim 7 wherein said encoded audio data has a frequency greater than approximately 19 kHz.

11. The accessory of claim 7 wherein said software residing in said electronic device is downloaded to said device through an internet interface of said electronic device.

12. The accessory of claim 7 wherein said electronic device is an internet connected mobile phone.

13. The accessory of claim 7 wherein said audio input is standard audio jack.

14. A method of communicating digital control data between an accessory and an electronic device having an audio input/output port, said method comprising:
providing application software that is downloaded to the device through a digital data interface of the device;
converting digital data to be transferred from the accessory to the device into an audio data file of selected frequency tones;
transferring the audio data file to the device through the audio input port of the device; and
converting the audio data file back into the original digital data with the application software.

15. The method of claim 14 further comprising converting user inputs on the device into digital control data for the accessory with application software, converting the digital accessory control data into an audio file, transferring the audio file to the accessory through the audio output of the device, converting the audio files into digital data in the accessory and using the control data to control a function of the accessory.

16. The method of claim 15 wherein said control data is converted into audio frequencies between approximately 19-20 KHz and superimposed upon an existing audio output of said device.

17. The method of claim 16 wherein said accessory converts said existing audio output into a radio frequency modulated output and transmits said radio frequency modulated output to a remote stereo receiver

18. The method of claim 14 wherein said accessory is a voice recorder.

19. The method of claim 14 wherein said accessory is an FM transmitter

20. The method of claim 14 wherein the digital data interface of the device is an internet interface and the application software is downloaded via the internet interface.
